(19) United States
(12) Patent Application Publication
(10) Pub. No.: US 2007/0280257 A1
(43) Pub. Date: Dec. 6, 2007

(54) Service discovery section

(75) Inventors: Jani Vare, Kaarina (FI); Jarno Kallio, Turku (FI); Kari S. Virtanen, Merimasku (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/443,317

(22) Filed: May 31, 2006

(51) Int. Cl. H04L 12/56

(52) U.S. Cl. 370/395.3

(57) ABSTRACT

Provided are apparatuses and methods for transmitting and receiving a service discovery section (SDS) associated with a service. In one example, the SDS corresponds to a channel identifier and contains mapping information. The mapping information may map the channel identifier to a packet identifier for the service. In addition, the mapping information may contain mapping information for IP addresses corresponding to the channel identifier, information identifying the network for transmission, a cell in which data is transmitted or priority information for the data.

### FIELD OF THE INVENTION

The invention relates generally to communications networks. More specifically, the invention relates to discovery of services in a communication network.

### BACKGROUND OF THE INVENTION

Digital broadband broadcast networks enable end users to receive digital content including video, audio, data, and so forth. Using a mobile terminal, a user may receive digital content over a wireless digital broadcast network. Digital content can be transmitted in a cell within a network. A cell may represent a geographical area that may be covered by a transmitter in a communication network. A network may have multiple cells and cells may be adjacent to other cells.

A receiver device such as a mobile terminal may receive a program or service in a data or transport stream. The transport stream carries individual elements of the program or service such as the audio and video components of a program or service. Typically, the receiver device locates the different components of a particular program or service in a data stream through Program Specific Information (PSI) or Service Information (SI) embedded in the data stream. However, PSI or SI signaling may be insufficient in some wireless communications systems, such as DVB-H systems. Use of PSI or SI signaling in such systems may result in a sub-optimal end user experience as the PSI and SI tables carrying in PSI and SI information may have long repetition periods. In addition, PSI or SI signaling requires a large amount of bandwidth which is costly and also decreases efficiency of the system.

Therefore, there exists a need for a method and system for service discovery in an efficient manner. There is also a need for mapping of parameters of a data stream in a current and neighboring cell of a network.

### BRIEF SUMMARY OF THE INVENTION

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the more detailed description below.

In one example, a method is provided for receiving a program or service at a mobile terminal in which a service discovery section (SDS) may provide at least one parameter and mapping information corresponding to the program or service. For example, the SDS may contain information for mapping a channel identifier to at least one packet identifier (PID) corresponding to the program or service.

In another example, a method is provided for constructing and transmitting an SDS including allocating at least one parameter pertaining to a program or service. The SDS may include, for example, a parameter for indicating a channel for transmitting the program or service and/or a parameter of identifying a data packet of the program or service.

In another example, a receiving device is provided for receiving a service and a corresponding SDS.

In another example, a transmitting device is provided for transmitting a service and a corresponding SDS. In addition, the transmitting device may construct the SDS for transmission.

In another example, a computer-readable medium is provided for controlling a device for discovering a service and receiving an SDS.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a suitable digital broadband broadcast system 102 in which one or more illustrative embodiments of the invention may be implemented.

FIG. 2 illustrates an example of a mobile device in accordance with an aspect of the present invention.

FIG. 3 illustrates an example of cells, each of which may be covered by a different transmitter in accordance with an aspect of the present invention.

FIG. 4 illustrates the OSI reference model as containing seven layers.

FIG. 5A illustrates an example of a structure of an SDS for providing parameters for service discovery in accordance with an aspect of the present invention.

FIG. 5B is a block diagram illustrating the SDS of FIG. 5A in accordance with an aspect of the present invention.

FIG. 6 illustrates an example of the hierarchical priority parameter indicating the hierarchical priority of the transport stream in accordance with an aspect of the present invention.

FIG. 7 illustrates an example of mapping of parameters associated with a data or service communication in OSI layers in accordance with an aspect of the present invention.

FIG. 8 illustrates another example of an SDS in accordance with an aspect of the present invention.

FIG. 9 is a block diagram illustrating the SDS of FIG. 8 in accordance with an aspect of the present invention.

FIG. 10A illustrates another example of an SDS in accordance with an aspect of the present invention.

FIG. 10B is a block diagram illustrating the SDS of FIG. 10A in accordance with an aspect of the present invention.

FIG. 11A also illustrates an example of an SDS for providing instant channel discovery in accordance with an aspect of the present invention.

FIG. 11B is a block diagram illustrating the SDS of FIG. 11A in accordance with an aspect of the present invention.

FIG. 12 is a flowchart illustrating an example of a method for service discovery at a receiver or mobile terminal in accordance with an aspect of the present invention.

FIG. 13 is a flowchart illustrating an example of identifying SDS parameters for services at a transmitter in accordance with an aspect of the present invention.

FIG. 14 is a partial block diagram illustrating an example of a receiver device in accordance with an aspect of the present invention.

FIG. 15 is a partial block diagram illustrating an example of a transmitting device in accordance with an aspect of the present invention.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

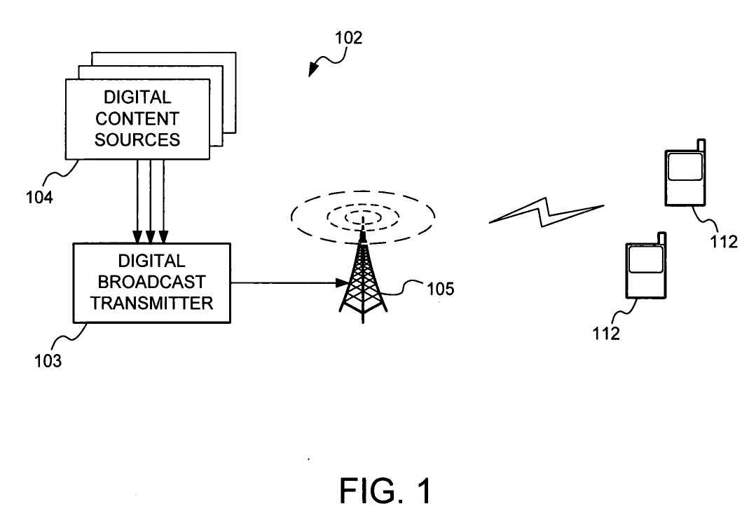

FIG. 1 illustrates a suitable digital broadband broadcast system 102 in which one or more illustrative embodiments of the invention may be implemented. Systems such as the one illustrated here may utilize a digital broadband broadcast technology, for example Digital Video Broadcast—Handheld (DVB-H) or next generation DVB-H networks such as DVB-H2. Examples of other digital broadcast standards which digital broadband broadcast system 102 may utilize include Digital Video Broadcast—Terrestrial (DVB-T), Integrated Services Digital Broadcasting—Terrestrial (ISDB-T), Advanced Television Systems Committee (ATSC) Data Broadcast Standard, Digital Multimedia Broadcast-Terrestrial (DMB-T), Terrestrial Digital Multimedia Broadcasting (T-DMB), Satellite Digital Multimedia Broadcasting (S-DMB), Forward Link Only (FLO), Digital Audio Broadcasting (DAB), and Digital Radio Mondiale (DRM). Other digital broadcasting standards and techniques, now known or later developed, may also be used. An aspect of the invention is also applicable to other multicarrier digital broadcast systems such as, for example, T-DAB, T/S-DMB, ISDB-T, and ATSC, proprietary systems such as Qualcomm MediaFLO/FLO, and non-traditional systems such 3GPP MBMS (Multimedia Broadcast/Multicast Services) and 3GPP2 BCMCS (Broadcast/Multicast Service).

Digital content may be created and/or provided by digital content sources 104 and may include video signals, audio signals, data, and so forth. Digital content sources 104 may provide content to digital broadcast transmitter 103 in the form of digital packets, e.g., Internet Protocol (IP) packets. A group of related IP packets sharing a certain unique IP address or other source identifier is sometimes described as an IP stream. Digital broadcast transmitter 103 may receive, process, and forward for transmission multiple IP streams from multiple digital content sources 104. The processed digital content may then be passed to digital broadcast tower 105 (or other physical transmission component) for wireless transmission. Ultimately, mobile terminals or devices 112 may selectively receive and consume digital content originating from digital content sources 104.

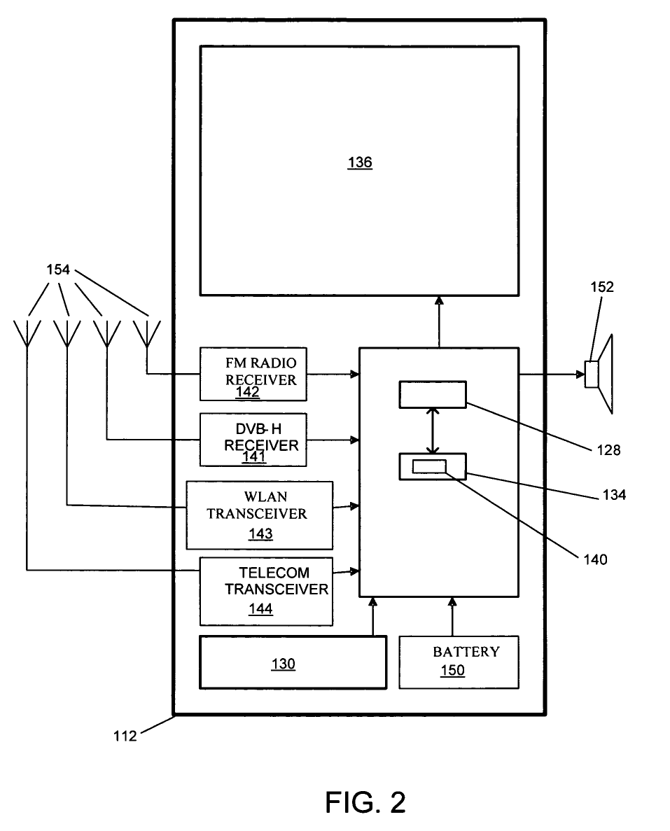

As shown in FIG. 2, mobile device 112 may include processor 128 connected to user interface 130, memory 134 and/or other storage, and display 136. Mobile device 112 may also include battery 150, speaker 152 and antennas 154. User interface 130 may further include a keypad, touch screen, voice interface, one or more arrow keys, joy-stick, data glove, mouse, roller ball, touch screen, or the like.

Computer executable instructions and data used by processor 128 and other components within mobile device 112 may be stored in a computer readable memory 134. The memory may be implemented with any combination of read only memory modules or random access memory modules, optionally including both volatile and nonvolatile memory. Software 140 may be stored within memory 134 and/or storage to provide instructions to processor 128 for enabling mobile device 112 to perform various functions. Alternatively, some or all of mobile device 112 computer executable instructions may be embodied in hardware or firmware (not shown).

Mobile device 112 may be configured to receive, decode and process digital broadband broadcast transmissions that are based, for example, on the Digital Video Broadcast (DVB) standard, such as DVB-H, DVB-H2, or DVB-MHP, through a specific DVB receiver 141. The mobile device may also be provided with other types of receivers for digital broadband broadcast transmissions. Additionally, receiver device 112 may also be configured to receive, decode and process transmissions through FM/AM Radio receiver 142, WLAN transceiver 143, and telecommunications transceiver 144. In one aspect of the invention, mobile device 112 may receive radio data stream (RDS) messages.

In an example of the DVB standard, one DVB 10 Mbit/s transmission may have 200, 50 kbit/s audio program channels or 50, 200 kbit/s video (TV) program channels. The mobile device 112 may be configured to receive, decode, and process transmission based on the Digital Video Broadcast-Handheld (DVB-H) standard or other DVB standards, such as DVB-MHP, DVB-Satellite (DVB-S), or DVB-Terrestrial (DVB-T). Similarly, other digital transmission formats may alternatively be used to deliver content and information of availability of supplemental services, such as ATSC (Advanced Television Systems Committee), NTSC (National Television System Committee), ISDB-T (Integrated Services Digital Broadcasting—Terrestrial), DAB (Digital Audio Broadcasting), DMB (Digital Multimedia Broadcasting), FLO (Forward Link Only) or DIRECTV. Additionally, the digital transmission may be time sliced, such as in DVB-H technology. Time-slicing may reduce the average power consumption of a mobile terminal and may enable smooth and seamless handover. Time-slicing entails sending data in bursts using a higher instantaneous bit rate as compared to the bit rate required if the data were transmitted using a traditional streaming mechanism. In this case, the mobile device 112 may have one or more buffer memories for storing the decoded time sliced transmission before presentation.

In addition, an Electronic Service Guide (ESG) may be used to provide program or service related information. Generally, an Electronic Service Guide (ESG) enables a terminal to communicate what services are available to end users and how the services may be accessed. The ESG includes independently existing pieces of ESG fragments. Traditionally, ESG fragments include XML documents, but more recently they have encompassed a vast array of items, such as for example, a SDP (Session Description Protocol) description, textual file, or an image. The ESG fragments describe one or several aspects of currently available (or future) service or broadcast program. Such aspects may include for example: free text description, schedule, geographical availability, price, purchase method, genre, and supplementary information such as preview images or clips. Audio, video and other types of data including the ESG fragments may be transmitted through a variety of types of networks according to many different protocols. For example, data can be transmitted through a collection of networks usually referred to as the “Internet” using protocols of the Internet protocol suite, such as Internet Protocol (IP) and User Datagram Protocol (UDP). Data is often transmitted through the Internet addressed to a single user. It can, however, be addressed to a group of users, commonly known as multicasting. In the case in which the data is addressed to all users it is called broadcasting.

One way of broadcasting data is to use an IP datacasting (IPDC) network. IPDC is a combination of digital broadcast and Internet Protocol. Through such an IP-based broadcasting network, one or more service providers can supply different types of IP services including on-line newspapers, radio, and television. These IP services are organized into one or more media streams in the form of audio, video and/or other types of data. To determine when and where these streams occur, users refer to an electronic service guide (ESG). One type of DVB is Digital video broadcasting-handheld (DVB-H). The DVB-H is designed to deliver 10 Mbps of data to a battery-powered terminal device.

DVB transport streams deliver compressed audio and video and data to a user via third party delivery networks. Moving Picture Expert Group (MPEG) is a technology by which encoded video, audio, and data within a single program is multiplexed, with other programs, into a transport stream (TS). The TS is a packetized data stream, with fixed length packets, including a header. The individual elements of a program, audio and video, are each carried within packets having a unique packet identification (PID). To enable a receiver device to locate the different elements of a particular program within the TS, Program Specific Information (PSI), which is embedded into the TS, is supplied. In addition, additional Service Information (SI), a set of tables adhering to the MPEG private section syntax, is incorporated into the TS. This enables a receiver device to correctly process the data contained within the TS.

As stated above, the ESG fragments may be transported by IPDC over a network, such as for example, DVB-H to destination devices. The DVB-H may include, for example, separate audio, video and data streams. The destination device must then again determine the ordering of the ESG fragments and assemble them into useful information.

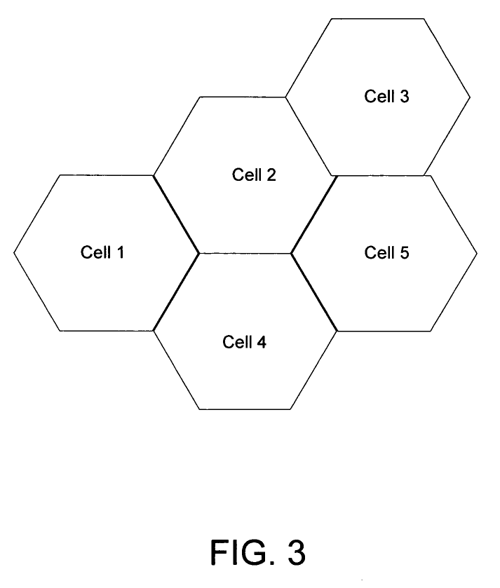

In a typical communication system, a cell may define a geographical area that may be covered by a transmitter. The cell may be of any size and may have neighboring cells. FIG. 3 illustrates an example of cells, each of which may be covered by a different transmitter. In this example, Cell 1 represents a geographical area that is covered by a transmitter for a communication network. Cell 2 is next to Cell 1 and represents a second geographical area that may be covered by a different transmitter. Cell 2 may, for example, be a different cell within the same network as Cell 1. Alternatively, Cell 2 may be in a network different from that of Cell 1. Cells 1, 3, 4, and 5 are neighboring cells of Cell 2, in this example.

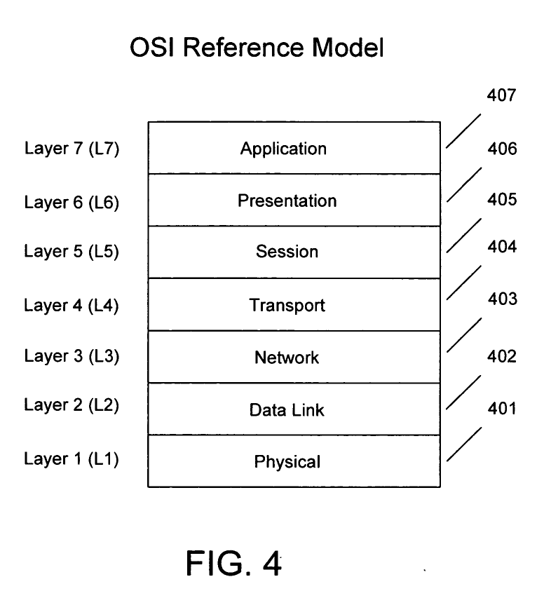

Communication between network components may be accomplished via the Open Systems Interconnection (OSI) standard. The OSI framework of the process for communication between different network components may be structured as seven layers or categories as described by the OSI reference model. FIG. 4 illustrates the OSI reference model as containing seven layers. Typically, layers 4-7 pertain to end-to-end communications between message source and message destination and layers 1-3 pertain to network access. Layer 1 (401, the physical layer) deals with the physical means of sending data over lines. This may include, for example, electrical, mechanical or functional control of data circuits. Layer 2 (402, the data link layer) pertains to procedures and protocols for operating communication lines. Also, detection and correction of message errors may be accomplished in Layer 2. Layer 3 (403, network layer) determines how data is transferred between different network components. Also, Layer 3 (403) may address routing in networks. Layer 4 (404, Transport layer) pertains to defining rules for information exchange. Layer 4 (404) may also be involved in the end-to-end delivery of information within and between networks. This information may further include error recovery and flow control. Layer 5 (405, Session layer) pertains to dialog management in Layer 5 (405) and may control use of basic communications facilities provided by Layer 4 (404, transport layer). Layer 6 (406, presentation layer) pertains to providing compatible interactivity between data formats. Layer 7 (407, application layer) provides functions for particular applications services. These functions may include file transfer, remote file access and/or virtual terminals.

In one example, information pertaining to a data transmission may be provided in a service discovery section (SDS). Information provided in the SDS may provide for service discovery by a receiver or mobile terminal. For example, the SDS may include a channel identifier (channel ID) to identify a channel over which data is transmitted. The SDS may further include mapping of the channel ID to a packet identifier (PID) associated with a data packet in the data stream. Also, the SDS may further map the channel ID to PID within a cell of a network or between different cells of the network. The SDS may be transmitted to the receiver or mobile terminal periodically at predetermined intervals. In one example, the SDS is transmitted every 100 ms. However, the SDS may be transmitted at any desired interval, including time intervals at less than 100 ms (e.g., 10 ms, 20 ms, 50 ms, 80 ms, etc), or greater than 100 ms (e.g., 120 ms, 150 ms, 180 ms, 200 ms or greater).

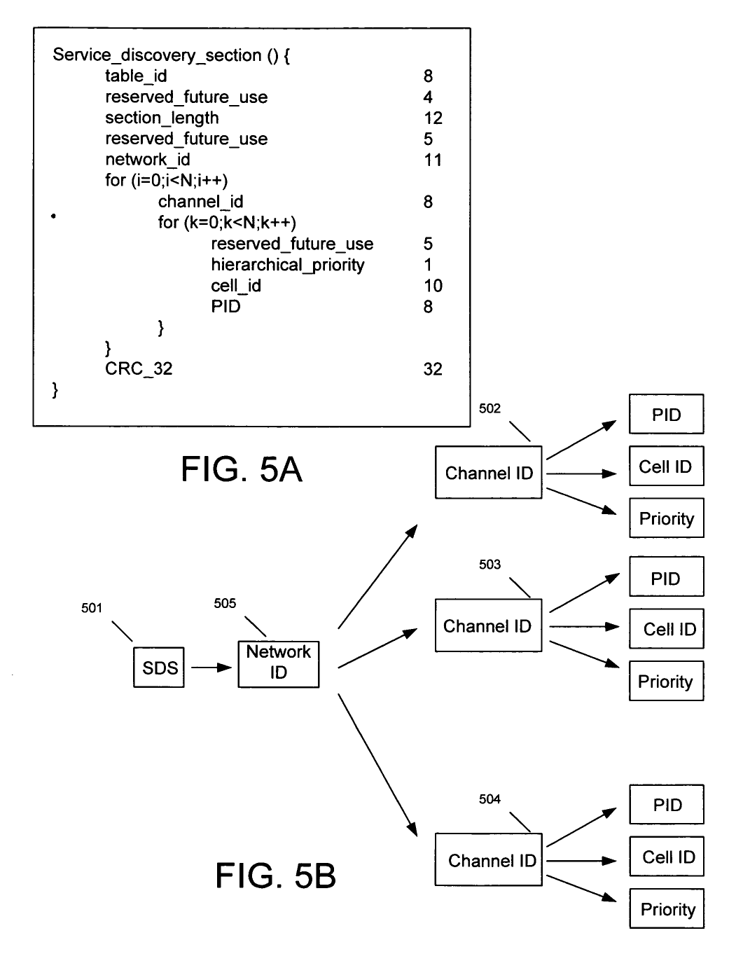

FIG. 5A illustrates an example of a structure of an SDS for providing parameters for service discovery. FIG. 5B is a partial block diagram illustrating the SDS of FIG. 5A. In this example, the SDS contains a parameter for identifying the service discovery section. As FIG. 5A illustrates, the SDS contains a “table_id” field that corresponds to an identifier that uniquely identifies the SDS. The SDS may further contain a parameter for indicating the length or size of the SDS. For example, a length parameter (illustrated as “section_length” in FIG. 5A) may provide the length of the section in bytes. The SDS may also contain a parameter for identifying the network. In this example, the SDS contains a “network_id” parameter that uniquely identifies the network in which the data communication is transmitted. The SDS also may contain a parameter for describing the channel such as a channel identifier that identifies a set of IP streams associated with a packet identifier (PID). In one example, the channel identifier is unique within a network and identifies all IP streams.

The SDS may further include a parameter for indicating the hierarchical priority of the transport stream. The IP streams of a channel may be carried within a transport stream that may be assigned a hierarchical priority. For example, one IP stream carried in a channel may be multiplexed into a high priority (HP) transport stream and a second IP stream carried in the channel may be multiplexed into a low priority (LP) transport stream. Further the SDS may include a number of bits that are reserved for future use and a checksum for example a cyclic redundancy check that may be of CRC-32 type.

FIG. 5B illustrates the example of FIG. 5A. In this example, the SDS 501 contains a parameter for indicating a channel ID (502-504). The channel ID may indicate the channel over which data is transmitted. FIG. 5B illustrates an exemplary SDS containing three channel IDs (502-504). However, any number of channel IDs may be indicated in the SDS 501. The SDS may correspond or be mapped to any number of network identifiers 505 for identifying a network over which data may be transmitted.

Also illustrated in the example of FIG. 5B, each channel ID (502, 503, or 504) may contain parameters for indicating any number of other parameters for describing the data transmission. In this example, to each channel identifier is associated with parameters for indicating a PID, Cell identifier and hierarchical priority of the data transmission. In one embodiment the SDS may be transmitted multiplexed in the transport stream in a similar way as PSI/SI data tables are sent. In another embodiment it may also be transmitted time-sliced and in a further embodiment it may be transmitted using MPE-FEC (multiprotocol encapsulation-forward error correction) scheme.

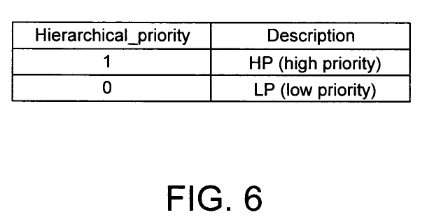

FIG. 6 illustrates an example of the hierarchical priority parameter indicating the hierarchical priority level of the transport stream. In this example, when the hierarchical priority parameter is “1”, the corresponding transport stream is transmitted as a high priority stream and when the hierarchical priority parameter is “0”, the corresponding transport stream is transmitted as a low priority stream. If the hierarchical priority is not used, then the parameter is set to ‘1’.

Also, the SDS may include a parameter for identifying a cell (e.g., a cell ID parameter). The cell ID parameter may be included in the SDS and is unique within a network. The SDS may also contain a PID parameter for identifying data packets of an elementary stream (data stream) in the transport stream. In DVB-H elementary stream is a stream of transport packets within a transport stream sharing a common Packet Identifier (PID).

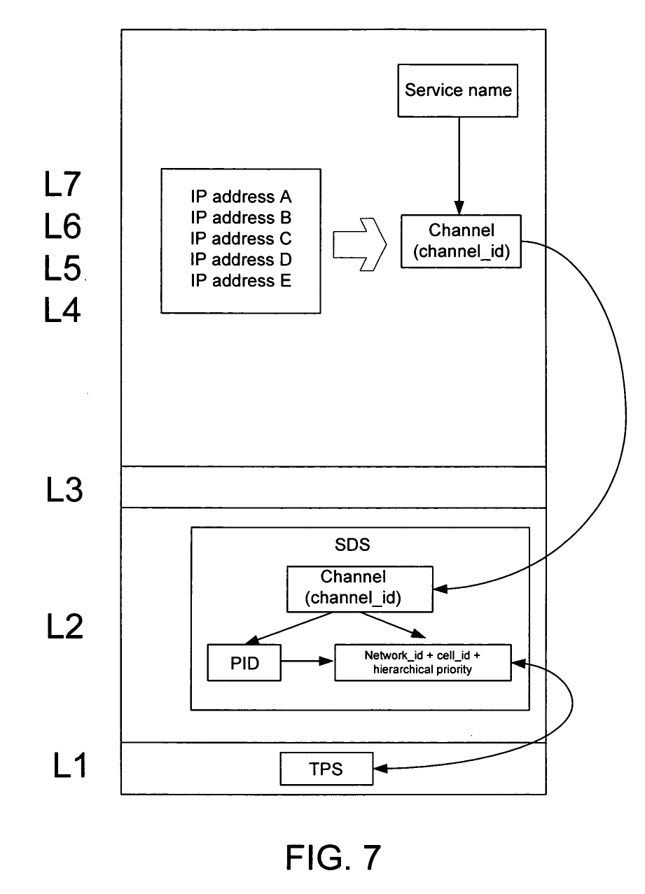

The channel ID may be mapped to corresponding IP addresses and/or port numbers within OSI layers 4-7. FIG. 7 illustrates an example of mapping of parameters associated with a data or service communication in OSI layers. In this example, a program or service is requested by a mobile terminal or receiver. The service is transported from a transmitter on a channel that may be identified via a channel identifier (e.g., channel_id). The channel identifier and associated channel corresponds to IP addresses of the data stream and is mapped to the corresponding IP addresses and/or port numbers associated with IP data streams in one or more of the OSI layers 4-7 as illustrated in FIG. 7. In addition, the associated transport streams contain data packets that are identifiable by corresponding PIDs. The PIDs associated with the data packets of the transport streams corresponding to the channel identifier are further indicated in the SDS within OSI layer 2 (the data link layer) as illustrated in the example of FIG. 7. The network identifier, cell identifier and hierarchical priority information can also be transmitted in Layer 1 in TPS bits as disclosed in U.S. application Ser. No. 11/339,527, incorporated herein in its entirety.

In the SDS, an associated PID is resolved for the identified channel (i.e., the channel identifier) and each of the IP addresses and PIDs associated with the channel identifier are identified. For example, based on the channel identifier of the desired service and the IP addresses associated with the channel identifier in the OSI layers 4-7, the corresponding PIDs, network identifiers, cell identifiers and/or hierarchical priority information may be obtained from the SDS in the OSI layer 2. After the parameters are obtained, the data may be received over the transmission channel. SDS may be carried within a transport stream in L2 or the SDS may be carried in time-sliced. Also, the SDS may be MPE-FEC protected.

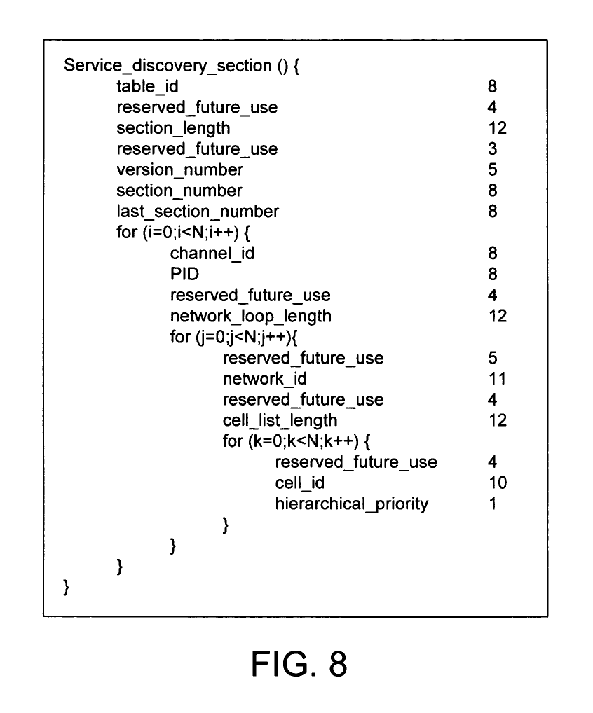

FIG. 8 illustrates another example of an SDS. In this example, the SDS contains a table identifier (table_id) for identifying the SDS. The SDS in FIG. 8 also contains a section_length parameter for indicating the length of the SDS. In addition, the SDS may also contain additional information pertaining to the SDS such as a version or section number (e.g., version_number parameter or section_number parameter). The version number may be used for indicating changes in the SDS in a similar way as in PSI/SI tables. If the SDS contains more than one section, the section numbering can be used for reassembling the SDS at the receiver. The parameters for section numbering, ‘section_number’ and ‘last_section_number’ can be used in a similar way as for PSI/SI tables.

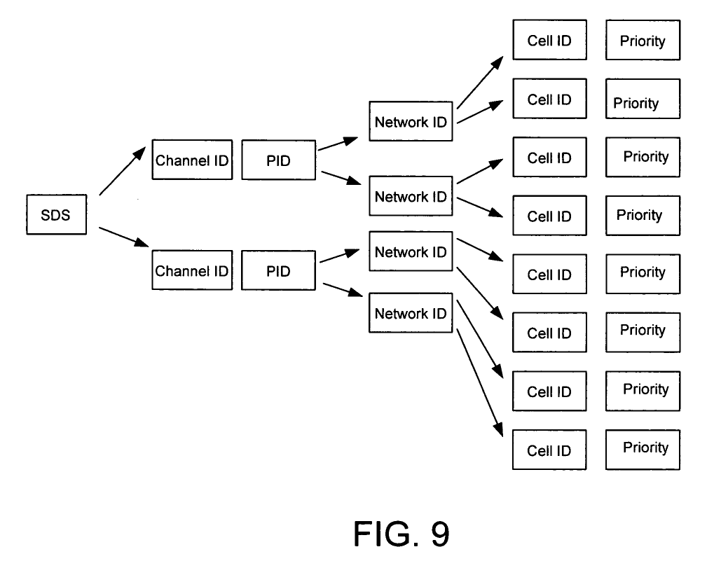

The SDS as in FIG. 8 also may provide cell identifier and hierarchical priority information for each network in the data transmission. The SDS of FIG. 8 contains a channel identifier for identifying the service provided over the transmission channel. The data transmitted corresponding to the service provided may be transmitted in data packets that may each be associated with an identifier (PID). The SDS further provides network identifiers for identifying such networks that transport the data streams having the same channel_id, PID combination. In addition, the cells of each identified network in which the data streams are transported are identified within the SDS with a cell identifier parameter and a hierarchical priority parameter is also provided in the SDS. Hence, the SDS of FIG. 8 also provides mapping for the cell identifiers and hierarchical priority information for each network and each network may be identified by a network identifier also provided in the SDS. FIG. 9 is a partial block diagram illustrating the example of FIG. 8. In this example, an SDS contains a parameter for indicating a channel identifier corresponding to the service desired. Also, the SDS may contain a PID for indicating a data packet for the desired service. Any number of channel ID, PID combinations may be contained in the SDS. FIG. 9 illustrates an SDS containing two channel ID, PID combinations, however, any number may be present.

Also illustrated in FIG. 9, each combination of channel identifier and PID may further be associated with a parameter for indicating a network (i.e., a network identifier). The network identifier may indicate a network over which the data may be transmitted. In the example illustrated in FIG. 9, two network IDs are illustrated for each channel ID, PID combination. However, any number of network identifiers may be associated with each channel ID, PID combination.

For each of the identified networks, as illustrated in the example of FIG. 9, any number of cell identifiers (for identifying the cell in which data is transmitted) and hierarchical priority information may be associated. The hierarchical priority information may provide an indication of the hierarchical priority of the data being transmitted.

Hence, as the example of FIG. 9 illustrates, an SDS may contain a parameter corresponding to a particular channel ID and PID pair or combination for a service data transmission. Any of the channel ID and PID pairs may correspond to any number of networks which may be indicated by a corresponding network identifier parameter. Also, any network or identifier for any network may be associated with any number of cell IDs (identifiers for identifying a cell in which the data is transmitted) and hierarchical priority used in the cell.

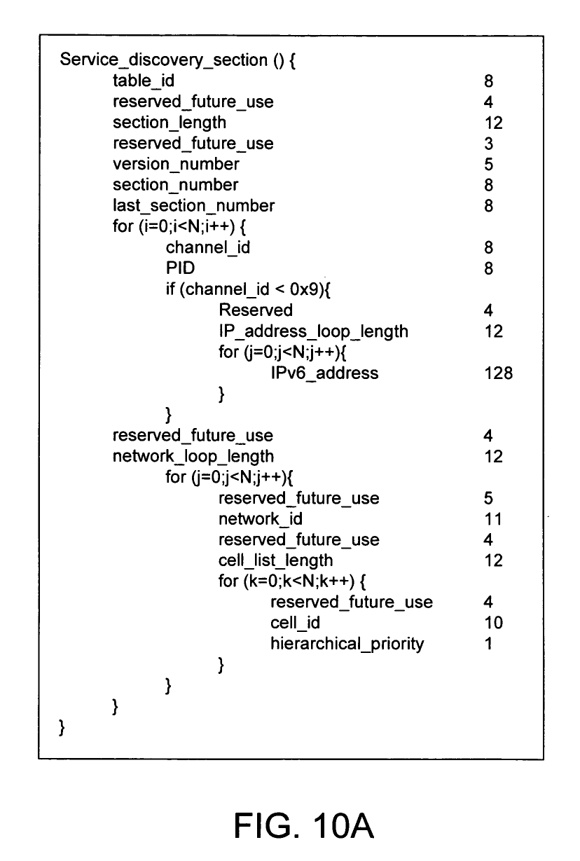

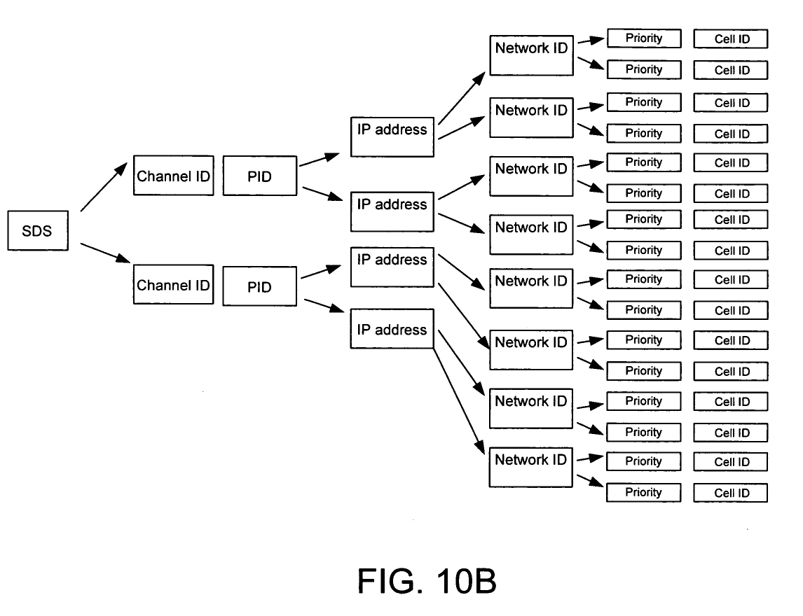

FIG. 10A illustrates another example of an SDS in which, for each PID and channel ID, an IP address is mapped (e.g., assigned IPv6_address). Hence, the SDS of FIG. 10A provides quick access to service. The SDS further provides a network identifier for identifying the network for transporting the data streams. In addition, the cell in which the data streams are transported is identified within the SDS with a cell identifier parameter and a hierarchical priority of the transport stream is provided using the hierarchical priority parameter also provided in the SDS. Hence, the SDS of FIG. 10A also provides mapping for the cell identifiers and corresponding hierarchical priority information for each network and each network may be identified by a network identifier also provided in the SDS.

FIG. 10B is a partial block diagram illustrating the SDS of FIG. 10A. In this example, an SDS may include a parameter for indicating any number of channel identifiers for identifying a desired service. In addition, the SDS may include a parameter for indicating any number of PIDs for data packets being transmitted for the service. Any of the channel ID and PID pairs may correspond or be mapped to any number of IP addresses, which may be associated with any number of network identifiers for identifying a network over which data may be transmitted. Also illustrated in FIG. 10B, any of the network identifiers may be further associated with any number of cell identifiers (for identifying a cell in which the data is to be transmitted) and corresponding hierarchical priority information for indicating the hierarchical priority of the service data to be transmitted.

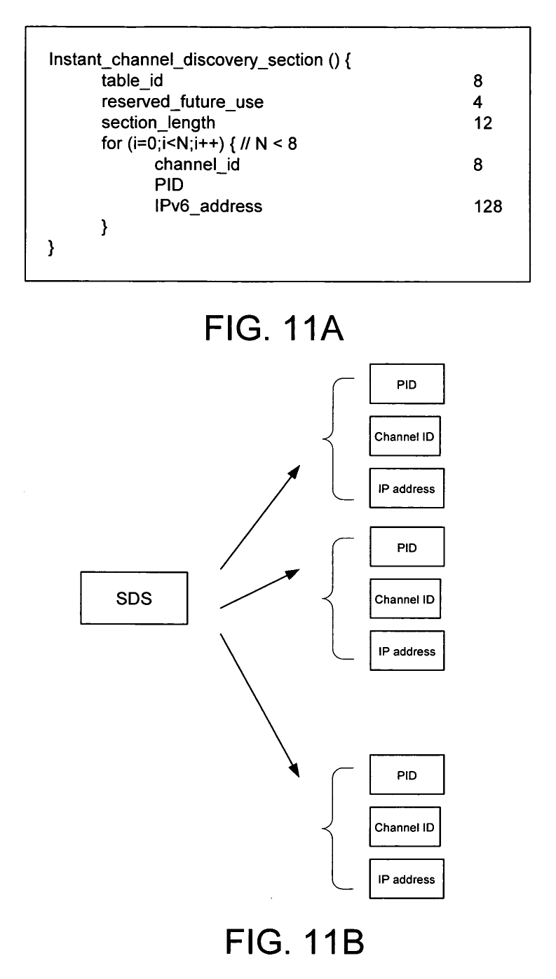

FIG. 11A also illustrates an example of an SDS for providing instant channel discovery. In this example, the SDS provides information based on a channel identifier of a channel for carrying the data transmission, announcing a PID associated with data packets of the data stream of the desired service and an associated IP address (e.g., IPv6_address). Each of the parameters provided in the SDS may be mapped for efficient data transport and quick discovery of services. In addition, in any of the SDSs, the mapping of channel identifiers with PID may be within a current cell of a network or between different cells of the network (e.g., with neighboring cells in the network).

FIG. 11B is a partial block diagram illustrating the SDS of FIG. 11A. The SDS may contain a parameter for indicating any number of packet identifiers (PIDs) for indicating data packets corresponding to a desired service. Also, the SDS may contain a parameter for indicating any number of transmission channels over which the desired service data may be transmitted (i.e., any number of channel identifiers). The SDS may also contain a parameter for indicating any number of IP addresses corresponding to the transmission and receipt of a desired service.

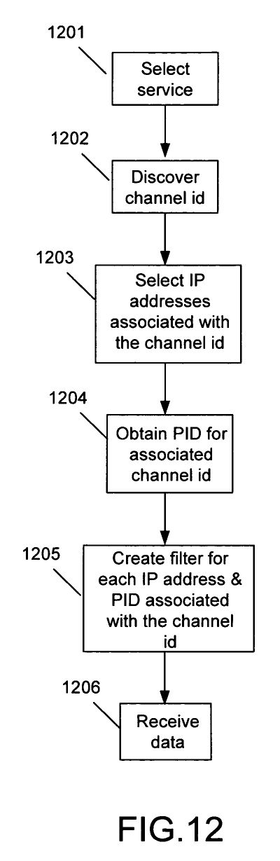

FIG. 12 is a flowchart illustrating an example of a method for service discovery at a receiver or mobile terminal. In this example, a desired service may be selected at the receiver or mobile terminal (STEP 1201). The selected service may include a name and may be associated with a transmission channel. For example, the service may be transported from a transmitter (network end) to the receiver or mobile terminal on a particular transmission channel and the transmission channel may be identified by the channel identifier (i.e., channel_id). The channel identifier may be discovered or identified from OSI layer 4-7 metadata (see, e.g., FIG. 7). After discovery of the channel identifier (STEP 1202), IP addresses corresponding to the discovered channel identifier and the selected service may be obtained (STEP 1203). For example, a filter may be applied to search for all IP addresses associated with the discovered channel identifier and the selected service. The filter may return all IP addresses that correspond to the discovered channel identifier and the selected service. Hence, specific IP addresses may be identified that are associated with the service requested and the transmission channels corresponding to the selected services. In one example, this mapping of the transmission channel or corresponding channel identifier with the service and the identification of corresponding IP addresses that correspond to the channel identifier and the desired service may be performed in OSI layers 4-7.

The channel identifiers are associated with one or more IP addresses within OSI layers 4-7. One service may be composed of one or more IP streams, each identified with IP address. The service discovery for each service can be carried by means of channel identifiers, which each are mapped with OSI layer 1 and 2 parameters within SDS sections. The number of SDS sections depends on the section size used and/or on the number of services, L1-L2 parameters, number of IP streams per service etc.

The identified SDS may contain mapping information for identifying a PID corresponding to data packets of a data stream for transmission in the transmission channel. From the SDS, the PID for an associated channel identifier may be determined (STEP 1204). Also, the mapping of the PID with the associated channel identifier may be performed in the OSI layer 2 (data link layer). In STEP 1205, a filter may be created for each of the IP addresses associated with the transmission channel and desired service and corresponding PIDs. A corresponding data stream (corresponding to the channel identifier, the desired service, associated IP addresses, and PID) may be received at the receiver or mobile terminal (STEP 1206).

The SDS may further map the channel identifier with PID, cell identifier, hierarchical priority of transport stream and network identifier such that a network corresponding to the transmission channel and data stream may be identified in the SDS. Also, the data transmission may be within a cell of a network. Hence, the desired service, corresponding channel identifier and IP addresses may be mapped to an SDS and the SDS may further map the parameters to PIDs associated with data packets in the data stream, hierarchical priority of transport stream, a network (via a network identifier such as network_id), and/or a cell within which the data is transported (e.g., via a cell identifier such as a cell_id parameter). The data may be transmitted over a physical connection such as in OSI layer 1. In another example, a computer-readable medium is provided for storing computer-executable code for performing the method described herein.

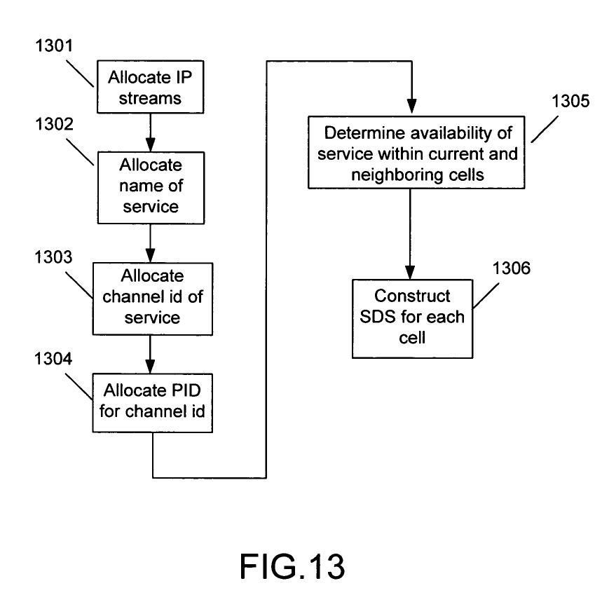

FIG. 13 is a flowchart illustrating an example of identifying SDS parameters for programs or services at a transmitter. In this example, data may be transmitted over a network via an IP-based broadcasting network. In STEP 1301, the programs or services are organized or allocated into one or more media streams (e.g., IP streams).

For example, programs or services may be organized into one or more media streams in the forms of audio, video, and/or other types of data. In addition, a name of the service may be allocated to the service (STEP 1302).

The data stream may be further allocated into packetized data or transport streams (TS). The TS may contain fixed length data packets that contain elements of the program or service being transmitted. Each of the data packets may have a packet identifier (PID). In STEP 1303, the transmitter may further allocate a channel identifier for identifying the transmission channel over which the program or service is transmitted. In addition, the PIDs associated with the data packets of the TS may be mapped to a corresponding channel identifier (STEP 1304). Mapping between a channel identifier and PID associated with the channel identifier may be performed for each IP stream or for each service to be transmitted.

Also, within a cell of a network, the availability of a program or service may be determined within the cell or neighboring cells (STEP 1305). If the program or service is determined to be available in the cell or neighboring cells, then the SDS may be constructed based on the allocated service, channel identifier and/or PID. Hence, when the program or service is available in the cell (or neighboring cell) of the network, an SDS is constructed at the transmitter containing mapping information for parameters of the program or service (STEP 1306). For example, a cell identifier may be allocated for identification of the cell in which the program or service is to be transmitted. Similarly, a network identifier may be allocated for identifying the network in which the program or service is to be transmitted. Also, hierarchical priority information of the transport stream may be included or allocated in the SDS. Each of the parameters may be associated with the channel identifier or channel corresponding with the service. Thus, an SDS may be constructed that contains parameters for indicating a particular program or service and corresponding parameters for indicating PIDs for data packets of the program or service, a channel identifier for indicating the transmission channel over which the program or service is to be transmitted, a cell identifier, network identifier, and/or hierarchical priority identifier for indicating the cell and network in which the program or service is available and the hierarchical priority of the transport stream (STEP 1306). Also in one example, the SDS may be transported in OSI layer 2 (data link layer). In another example, a computer-readable medium is provided for storing computer-executable code for performing the method described herein.

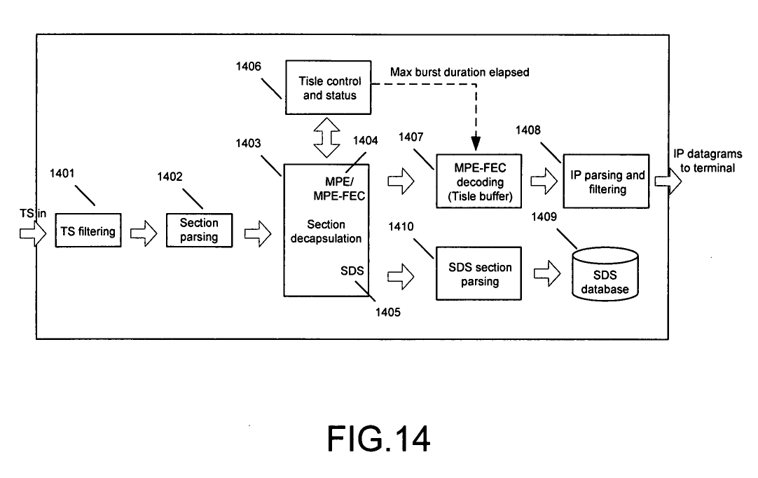

FIG. 14 is a partial block diagram for an example of a receiver according to an aspect of the invention. The input is illustrated as a TS (Transport Stream) packet stream from an RF section of the receiving device. The output of the receiver block contains IP streams which are forwarded for storing and/or processing and rendering.

An input device of the receiver may receive the TS stream. For example, FIG. 14 illustrates an input device as the TS filtering block 1401 that receives the TS stream and, according to the PID value, passes through only the TS packets belonging to desired elementary streams. There may also be an option to choose whether erroneous packets are discarded or passed forward. For example, SDS sections may be carried on certain elementary streams, which may change dynamically or be defined as fixed values.

The section parsing block 1402 decapsulates the payload of the TS packets and forms sections from these payloads. The section parsing block 1402 may also take into account the possible adaptation field and payload unit start indicator (PUSI).

The section decapsulation block 1403 extracts the real time parameters and the payload of the section. According to the table_id, the section decapsulation block 1403 may send the payload along with real time parameters into the MPE/MPE-FEC 1404 or SDS 1405 output. In addition, the real time parameters may be sent to the timeslicing control and status block 1406. The SDS output 1405 may include any parameter as set forth above. For example, the SDS may contain a parameter for indicating a packet identifier (PID) for indicating data packets corresponding to a desired service, a transmission channel over which a desired service data may be transmitted, any number of channel identifiers, or a parameter for indicating any number of IP addresses corresponding to the transmission and/or receipt of a desired service.

The SDS output 1405 may be further processed in the SDS section parsing block 1410. For example, the SDS section parsing block 1410 may select discover a channel identifier (channel_id) in the SDS output 1405 of the section decapsulation block 1403 for transmission of a desired service. Also, the SDS section parsing block 1401 may select an IP address associated with the discovered channel identifier or obtain a PID corresponding to the channel identifier. The SDS section parsing block 1401 may further create a filter for each IP address and/or PID associated with the channel identifier for receiving the desired service.

The timeslicing control and status block 1406 may analyze the real time parameters and may generate different status data based on the analysis of the real time parameters. It may also signal the MPE-FEC decoding block 1407 when the maximum burst duration has elapsed. This signaling may be used to start the decoding if the end of the burst is lost.

The MPE-FEC decoding block 1407 may write the section payloads into an MPE-FEC frame according to the address information (real time parameter) and may decode the whole frame row by row. Erasure and non-erasure decoders may be implemented. The erasure info can be obtained from the section CRC-32 or, if the erroneous TS packets are passed forward, from a transport error indicator located in the header of the TS packet. If MPE-FEC is not used, then this block may function as a time slicing buffer by storing one burst at a time.

The IP parsing and filtering block 1408 receives the MPE-FEC frame and detects within the corrected data areas in the frame IP datagrams that were originally erroneous but were corrected by the decoder. The IP parsing and filtering block 1408 may pass through the IP datagrams with the desired IP address.

In addition, the SDS data may be delivered in a similar way as that described for the IP datagrams carrying application data (i.e., with MPE-FEC encoding).

The SDS data may be stored. In one example, the SDS may be stored to an SDS database 1409 via the SDS section parsing block 1410 and the receiver may utilize the SDS at a subsequent time for the discovery of IP services from the TS. Ultimately IP datagrams are forwarded to the terminal IP stack.

Also, one or more SDSs may be used in handover from one cell to another within the same network or may be received and stored in handover between networks. For example, in cases where quick access method is used, one or more SDSs received and stored may be used in handover between networks. In one example, of SDS being used in handover purposes, the terminal may receive and store one or more SDSs from the network with which it is connected. In one example, the SDSs carry version numbers and the terminal may replace old versions of SDSs with new versions. The received and stored SDSs may contain data on services that are transmitted in one or more neighboring cells and the data can be used for smooth and fast handover. The terminal may also discover the addresses and port numbers of the IP streams from the data in OSI layers 4-7 by using the channel identifier. The channel identifier may further be used for retrieving the additional data or parameters from the SDSs such as, for example, a corresponding PID, the cell identifier, and/or the hierarchical priority of the transport stream carrying the desired service.

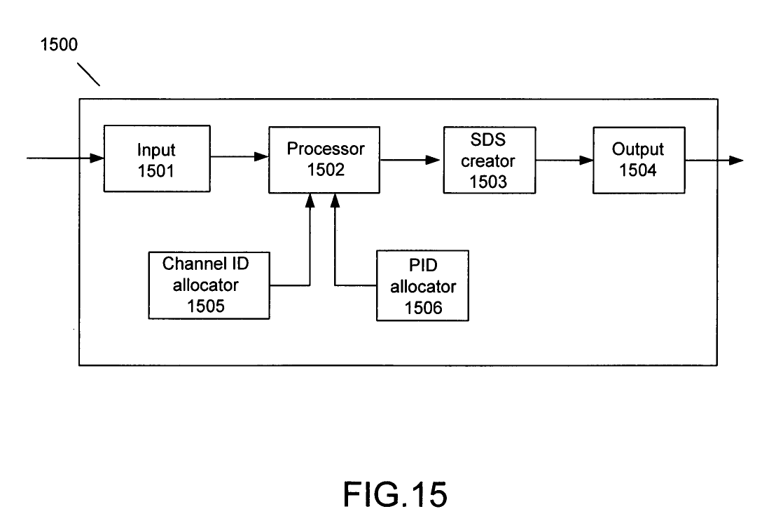

FIG. 15 is a partial block diagram illustrating an example of a transmitter for providing SDS information to a receiver or mobile terminal. In this example, the transmitter 1500 contains an input 1501 for receiving programs or services from a program or service source. The received data may be processed in a processor 1502 which may allocate the received data into IP streams. A channel ID allocator 1505 may further allocate a channel identifier for identifying a channel for transmission of the data stream. Similarly, a PID allocator 1506 may allocate a PID for data packets in the data stream. The channel identifier and PID thus allocated by the channel ID allocator 1505 and the PID allocator 1506, respectively, is further processed in an SDS creator 1503 that constructs an SDS for transmission to the receiver or mobile terminal. The SDS creator 1503 may determine the availability of a service within particular cells in a network and may construct the SDS as including a parameter for indicating the cell and/or network in which the data stream is to be transmitted. For example, the SDS creator 1503 may include a network identifier and/or a cell identifier in the SDS. Also, the SDS creator 1503 may include additional information in the SDS including hierarchical priority information of the transport stream (e.g., high priority or low priority).

In addition, a computer-readable medium is provided containing computer-readable instructions for performing any of the methods herein. For example, a computer-readable medium may include computer-readable instructions for receiving a service on a channel in a network and receiving a service discovery section (SDS) corresponding to the service. The SDS may contain mapping information for mapping characteristics of the transmission. For example, the SDS may contain mapping information for mapping a channel with a data packet associated with the transmitted service.

The embodiments herein include any feature or combination of features disclosed herein either explicitly or any generalization thereof. While the invention has been described with respect to specific examples including presently preferred modes of carrying out the invention, those skilled in the art will appreciate that there are numerous variations and permutations of the above described systems and techniques.

We claim:

1. A method of discovering a program or service at a mobile terminal comprising:
receiving a service selection;
associating the selected service with a first parameter;
discovering a service discovery section (SDS) corresponding to the first parameter;
retrieving from the SDS corresponding to the first parameter at least one packet identifier (PID) corresponding to the selected service.

2. The method of claim 1 wherein the SDS contains a second parameter for indicating a network over which the selected service is being transmitted.

3. The method of claim 1 wherein the SDS contains a second parameter for indicating a cell in which the selected service is being transmitted.

4. The method of claim 1 wherein the SDS contains a second parameter for indicating a hierarchical priority of the transport stream of the selected service.

5. The method of claim 1 wherein the discovering step comprises receiving the SDS periodically.

6. A method of transmitting a service discovery section (SDS) corresponding to a service, comprising:
organizing digital content of a service into one or more IP data streams;
allocating a parameter for indicating a channel for transmitting the one or more IP data streams;
determining a packet identifier (PID) for identifying a data packet in an elementary stream;
constructing the SDS including the parameter and PID; and
transmitting the SDS and the one or more IP data streams.

7. The method of claim 6 further comprising determining the availability of the service in a network for transmitting the one or more IP data streams.

8. The method of claim 7 wherein the step of constructing the SDS comprises allocating a second parameter for indicating the network for transmitting the one or more IP data streams.

9. The method of claim 6 further comprising determining the availability of the service in a cell of a network for transmitting the one or more IP data streams.

10. The method of claim 9 wherein the step of constructing the SDS comprises allocating a second parameter for indicating the cell for transmitting the one or more IP data streams.

11. The method of claim 6 wherein the step of transmitting comprises transmitting the SDS in OSI layer 2.

12. The method of claim 6 wherein the step of constructing the SDS further comprises determining a hierarchical priority of the transport stream carrying the one or more IP data streams and allocating a second parameter for indicating the determined hierarchical priority.

13. The method of claim 6 wherein the transmitting step comprises transmitting the SDS periodically.

14. An apparatus for transmitting a Service Discovery Section (SDS) corresponding to a service comprising:
an input device for receiving service information corresponding to a service;
a channel allocator for allocating a channel for transmitting the service;
a packet identifier (PID) allocator for allocating a PID for a data packet corresponding to the service;
an SDS creator for constructing an SDS corresponding to the service, the SDS containing information for mapping the channel to the PID;
an output device for transmitting the SDS and the service.

15. The apparatus of claim 14 wherein the output device transmits the SDS on OSI layer 2.

16. The apparatus of claim 14 wherein the SDS creator further constructs the SDS with at least one of a first parameter for indicating a network to transmit the service, a second parameter for indicating a cell in a network to transmit the service, and a third parameter for indicating a hierarchical priority of the transport stream carrying the service.

17. A computer-readable medium comprising computer-readable instructions for performing the steps of:
selecting a service transmitted on a channel in a network, the service including a data packet;
receiving a Service Discovery Section (SDS) corresponding to the service, the SDS including mapping information for mapping the channel and the data packet.

18. A receiver for receiving a Service Discovery Section (SDS) corresponding to a service comprising:
an input device for receiving a data stream corresponding to a service, the data stream including an SDS;
a section decapsulator for extracting a parameter corresponding to the SDS from the data stream;
a section parsing module for selecting the service based on the parameter.

19. The receiver of claim 18 wherein selecting the service based on the parameter includes discovering a channel identifier from OSI layer 4-7 metadata.

20. The receiver of claim 19 wherein the section parsing module further filters IP addresses associated with the channel identifier and the service.

21. The receiver of claim 19 wherein the channel identifier is mapped with OSI layer 1 or 2 parameters in the SDS.

22. The receiver of claim 19 wherein the section parsing module further determines a packet identifier (PID) associated with the channel identifier.

23. The receiver of claim 22 wherein the PID is mapped with the channel identifier in the OSI layer 2.

24. The receiver of claim 18 further comprising a storage for storing the SDS.
